(19) United States
(12) Patent Application Publication
(10) Pub. No.: US 2019/0276038 A1
(43) Pub. Date: Sep. 12, 2019

(54) VEHICLE TRAILER DETECTION SYSTEM

(71) Applicant: FORD GLOBAL TECHNOLOGIES, LLC, Dearborn, MI (US)

(72) Inventor: Donatus A. J. Kees, Billericay (GB)

(21) Appl. No.: 16/288,617

(22) Filed: Feb. 28, 2019

(30) Foreign Application Priority Data
Mar. 9, 2018 (GB) 1803799.4

(51) Int. Cl. B60W 40/10; G01P 13/00

(52) U.S. Cl. CPC B60W 40/10; G01P 13/00; B60D 1/58; B60W 2520/22; B60W 2300/14

(57) ABSTRACT

A trailer detection system for a vehicle and method of operation may include a first sensor configured to detect at least one of a vertical and a lateral displacement of a vehicle body relative to at least one wheel assembly of the vehicle and a processor, configured to process the detected displacement and to make a determination as to whether a trailer is connected to the vehicle.

### CROSS REFERENCE TO RELATED APPLICATIONS

The present application claim the benefit to UK patent application GB 1803799.4, filed Marc. 9, 2018, the contents of which are incorporated herein in their entirety.

### BACKGROUND OF THE INVENTION

The present disclosure relates to a trailer detection system and is particularly, although not exclusively, concerned with using a plurality of sensors to sense the displacement of a front wheel assembly from a vehicle body and a rear wheel assembly from the vehicle body, and using the instantaneous displacement values at each wheel assembly to infer whether a trailer is attached to the vehicle body.

Vehicle systems such as braking, steering or suspension systems, are typically configured to be optimal for the forces on the vehicle in normal use, such as friction from the wheels of the vehicle and air resistance resulting from the shape and size of the vehicle. However, when a vehicle is towing a trailer, additional forces are also applied to the trailer, and transmitted to the vehicle via means such as a tow bar. These additional forces affect handling of the vehicle, and can also affect the effectiveness of braking, steering and suspension, rendering the vehicle less safe to drive. Vehicle systems such as the brake system may be adjusted by altering the front to rear brake balance and vehicle stability algorithms to compensate for the additional forces caused by the trailer on the vehicle, thus achieving a safer operation of the vehicle. It is therefore advantageous for a vehicle to be able to reliably detect when a trailer is being towed, so vehicle systems can be adjusted accordingly.

Various methods have been used to indicate if a trailer is connected to the tow bar of a vehicle, such as methods which identify additional energy consumption from lights on the trailer and infer that a trailer must therefore be connected to the vehicle. However, these methods are often unable to reliably determine if a trailer is connected to the vehicle, and may be falsely triggered by use of other attachments such as light boards used with a rear mounted bike rack. This may result in an inaccurate compensation of vehicle systems, which could make the vehicle less safe. It is therefore desirable for a vehicle to be able to detect the presence of a trailer with a very high level of accuracy.

### SUMMARY OF THE INVENTION

According to an aspect of the present disclosure, there is provided a trailer detection system for a vehicle, the detection system comprising a first sensor configured to detect at least one of a vertical and a lateral displacement of a vehicle body relative to at least one wheel assembly of the vehicle; and a processor, configured to process the detected displacement and to make a determination as to whether a trailer is connected to the vehicle.

The detected displacement may be compared to a threshold value by the processor. The threshold value may be a predetermined value that indicates that a trailer is connected to the vehicle.

When the sensor is measuring vertical displacement at a front axle of a vehicle, the threshold displacement may be greater than a normal range of operational displacement of the vehicle body relative to the at least one wheel assembly of the vehicle without a trailer attached.

When the sensor is measuring vertical displacement at a rear axle of a vehicle, the threshold displacement may be less than a normal range of operational displacement of the vehicle body relative to the at least one wheel assembly of the vehicle without a trailer attached.

The processor may perform Fast Fourier Transform analysis in order to make a determination as to whether a trailer is connected to the vehicle.

The Fast Fourier Transform analysis may be used to calculate the frequency of oscillation of the vehicle. The processor may be configured to determine if the calculated frequency of oscillation is indicative of a trailer being connected to the vehicle.

The first sensor may comprise at least one lateral sensor configured to detect the lateral displacement of the at least one wheel assembly relative to the vehicle body.

A second sensor may be provided. The second sensor may be configured to detect at least one of a vertical and a lateral displacement of the vehicle body relative to another wheel assembly associated with a different axle of the vehicle from the first sensor.

The processor may use the displacement measured by the first sensor and the displacement measured by the second sensor to make a determination as to whether a trailer is connected to the vehicle.

At least one of the first sensor and the second sensor may comprise at least one of a contactless proximity sensor and a contact sensor. The contact sensor may be connected to both the vehicle body and the wheel assembly.

The contact sensor may comprise a sensor body and a probe which is able to move relative to the sensor body. The sensor body may be attached to at least one of the vehicle body and the wheel assembly and the probe may be attached to the other of the vehicle body and the wheel assembly.

The probe may be rotatably connected to the sensor body and to at least one of the vehicle body and the wheel assembly. The sensor may be configured to detect rotation of the probe relative to the sensor body. The probe may be rotatably connected by at least one of a hinge or a ball joint.

The sensor may further comprise a potentiometer or a rotation encoder which detects rotation of the probe relative to the sensor body. The probe may be slideably received within the sensor body, and the sensor may be configured to detect translation of the probe relative to the sensor body.

At least one of the first sensor and the second sensor may be configured to detect both the vertical and the lateral displacement of the vehicle body relative to the at least one wheel assembly of the vehicle.

The first sensor may be configured to detect one of the vertical and the lateral displacement of the vehicle body relative to the at least one wheel assembly of the vehicle. At least one additional first sensor may be provided to detect the other of the vertical and the lateral displacement of the vehicle body relative to the at least one wheel assembly of the vehicle.

The second sensor may be configured to detect one of the vertical and the lateral displacement of the vehicle body relative to the other wheel assembly of the vehicle. At least one additional second sensor may be provided to detect the other of the vertical and the lateral displacement of the vehicle body relative to the other wheel assembly of the vehicle.

The wheel assembly may comprise an axle extending across a centerline of the vehicle.

According to another aspect of the present disclosure there is provided a method of performing trailer detection for a vehicle, the method comprising using a sensor to detect at least one of a vertical and a lateral displacement of a vehicle body relative to at least one wheel assembly of the vehicle; processing the detected displacement; and making a determination as to whether a trailer is connected to the vehicle, based on the processed displacement.

The detected displacement may be compared to a threshold value. The threshold value may be a predetermined value that indicates that a trailer is connected to the vehicle.

The method may further comprise making a Fast Fourier Transform analysis in order to make a determination as to whether a trailer is connected to the vehicle.

The Fast Fourier Transform analysis may be used to calculate the frequency of oscillation of the vehicle. The processor may be configured to determine if the calculated frequency of oscillation is indicative of a trailer being connected to the vehicle.

The method may further comprise detecting at least one of a vertical and a lateral displacement of the vehicle body relative to another wheel assembly associated with a different axle of the vehicle, and may use the displacement of the wheel assembly and another wheel assembly to determine whether a trailer is connected to the vehicle.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a diagram showing the forces acting on a vehicle and a trailer;

FIG. 2a is a diagram showing the center of gravity of an unloaded vehicle;

FIG. 2b is a diagram showing the center of gravity of a vehicle carrying a load;

FIG. 2c is a diagram showing the vehicle towing a trailer;

FIGS. 3a and 3b are diagrams showing the force acting on a trailer and vehicle when the vehicle is turning;

FIG. 4 is a diagram showing an example of a sensor for measuring the displacement of a vehicle body relative to a wheel assembly; and

FIG. 5 is a diagram showing an example of a sensor for measuring the displacement of a vehicle body relative to a wheel assembly.

### DETAILED DESCRIPTION

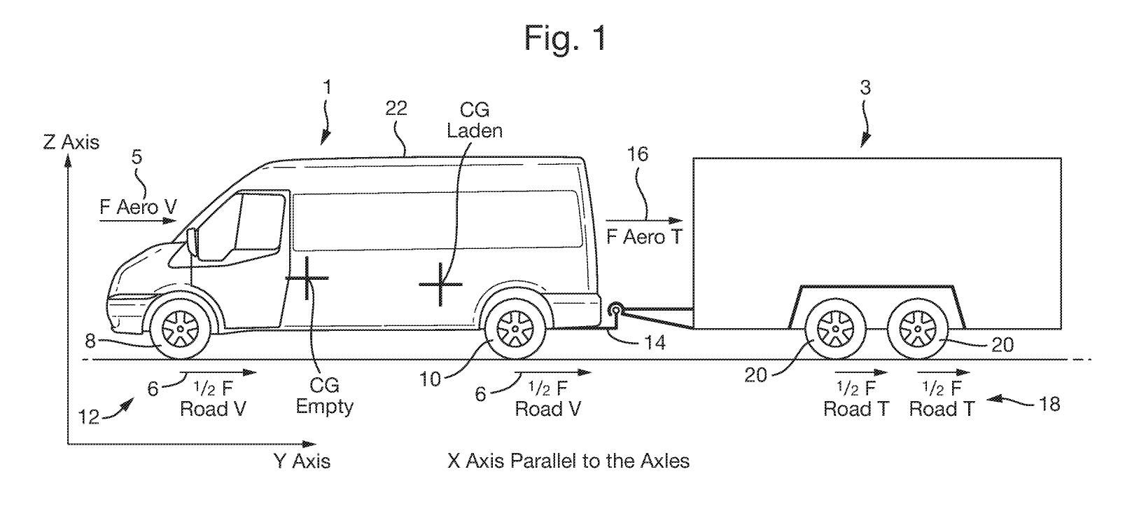

FIG. 1a illustrates the forces present when a vehicle 1 is towing a trailer 3. The vehicle 1 itself will, in normal use, have several forces acting against its direction of motion. For example, vehicle air resistance 5, which will depend on the size and shape of the vehicle 1, will act against the motion of the vehicle 1. Vehicle friction 6 caused by the interaction of the wheels 8, 10 with a road 12 will also oppose the motion of the wheels 8, 10, and thus the vehicle 1. The resistance from vehicle friction 6 will be dependent on the weight of the vehicle 1, including any loads carried by the vehicle, in addition to the coefficient of friction between the wheels 8, 10 and the road 12.

As is shown in FIG. 1, when a trailer 3 is being towed, similar forces are also applied to the trailer. Air resistance will cause a resultant force on trailer 3. The trailer air resistance 16 will at least partly depend on the shape and size of the trailer. As is also shown in this Figure, trailer friction 18 caused by the resistance of the road 12 to the movement of the wheels of the trailer 20 will also cause a resultant force to be applied against the motion of the trailer. The friction force on the trailer will be dependent on the weight of the trailer and the coefficient of friction between the wheels of the trailer and the road. Forces caused by the presence of a trailer will be transmitted to the vehicle 1 via the tow bar 14 (also called a trailer hitch). Thus, a vehicle 1 towing a trailer 3 will have its forward motion further opposed at least by additional force caused by trailer air resistance 16 on the trailer 3 and trailer friction 18 caused by the interaction of the trailer wheels 20 with the road 12.

Conventional road vehicles 1 are provided with suspension, which allows a vehicle body 22 to move relative to a wheel assembly 8, 10 of the vehicle. The wheel assembly may comprise one or more wheels fitted with pneumatic tires rotating about a hub which is suspended from the vehicle body by a suspension assembly. The suspension assembly may comprise leading or trailing arms and a resilient element such as a leaf or coil spring or an air suspension unit. The wheel assembly may be connected to a second wheel assembly by an axle which extends across a centerline of the vehicle.

The additional force applied to the vehicle body 22 via the tow bar 14 when towing the trailer 1 will cause the wheel assembly 8, 10 to move in a forward direction slightly, relative to the vehicle body 22. The forward motion of the vehicle body will be resisted by the air resistance on the vehicle body, but also by the forces which resist forward motion of the trailer. Thus, as the vehicle moves forward, dragging the trailer behind it, the relative movement of the wheel assembly with respect to the vehicle body will cause the wheel assembly to move slightly in a direction towards the front of the vehicle body 22, i.e. there will be a displacement on the y axis between the wheel assembly 8, 10 and the vehicle body 22.

A similar occurrence will result from loading of the vehicle 1. When a vehicle is provided with additional weight, for example by placing additional items into the vehicle, a greater force will be required to accelerate the vehicle body 22. Thus, the additional weight will cause a displacement between the wheel assembly 8, 10 and the vehicle body 22 when the vehicle 1 is accelerating.

The additional forces on a vehicle 1 caused by towing the trailer 3 could result in an equivalent resistance to forward motion of the vehicle 1 as is generated by a vehicle which is heavily laden but is not towing a trailer. In such circumstances, towing the trailer will therefore result in the same net displacement on the y axis of the vehicle body 22 relative to the wheel assembly 8, 10, as is experienced by a heavily laden vehicle. Thus, it would be difficult to distinguish, from the displacement of the vehicle body on the y axis alone, a heavily laden vehicle from a lightly laden vehicle towing a trailer. Detection of displacement on the y axis could therefore provide a determination of whether a trailer is being towed, but would not provide high reliability.

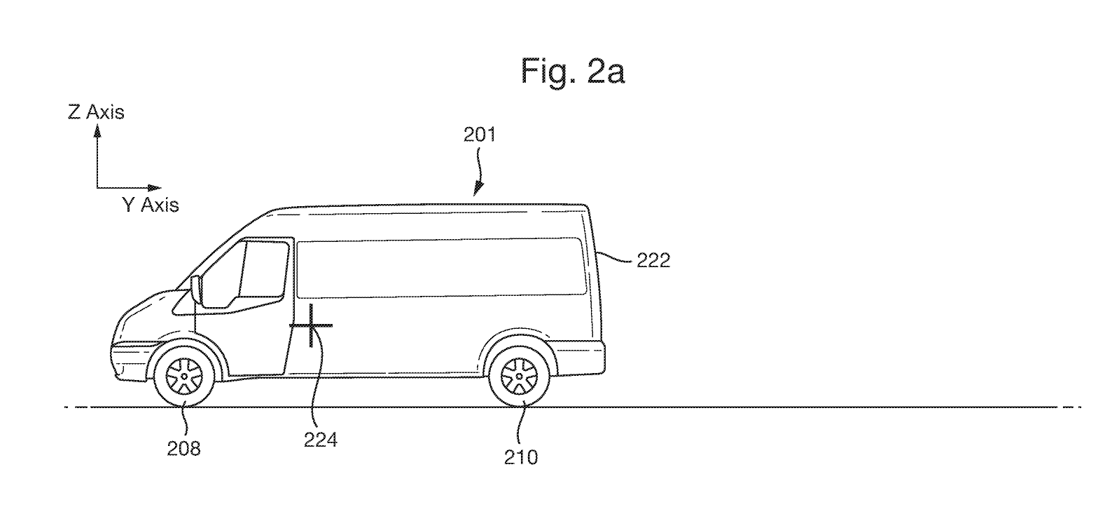

FIG. 2a shows the center of gravity of a typical unloaded vehicle 201. The center of gravity 224 is located between front 208 and rear 210 wheel assemblies. The vehicle body 222 is suspended relative to the front and rear wheel assemblies 208, 210 and the weight of the vehicle 201 is distributed through the suspension between the front and rear wheel assemblies 208, 210. When the vehicle 201 is loaded, for example with cargo in the rear of the vehicle, as is shown in FIG. 2b, the center of mass 224 of the vehicle 201 will be shifted towards the rear of the vehicle. The additional weight of cargo in the vehicle body will cause the vehicle body to move downwardly, compressing the suspension at the front and rear axles of the vehicle, so that the vehicle body moves closer in a vertical (z axis) direction to the wheel assemblies and to the road.

FIG. 2c shows a trailer 203 being towed by the vehicle 201, in a situation where the mass of the cargo carried by the vehicle 201 is approximately equal to the mass of the trailer 203. The mass of the trailer applies a load on the y axis as discussed above. This load is supported by wheels of the trailer and by a tow ball 226 of a tow hitch 214 fixed to the towing vehicle, typically above a wheel center of a rear wheel assembly 210. The force applied by the trailer on the tow hitch varies dynamically as the towing vehicle and trailer move over an undulating road surface, but for a large stationary trailer on a level road surface, the weight supported by the tow hitch 214 (the tongue weight) is ideally adjusted to about 100 to 150 Kg.

Thus, when the trailer 203 is connected to the tow hitch 214 of the vehicle 201, the vehicle 201 partially supports the trailer 203, and the load from the trailer is applied to the towing vehicle to the rear of the rear axle. Consequently, the front of the vehicle will ride slightly higher than it would without a trailer and the rear of the vehicle will ride slightly lower as a result of the down force on the z axis from the trailer onto the hitch 224, causing the vehicle to pivot about the rear axle. As the vehicle moves forward along an undulating road, the down force from the trailer onto the hitch 224 will vary significantly and may even change direction, causing the rear of the vehicle to pitch down as the front of the vehicle rises up, and vice versa.

When the vehicle brakes, the momentum of an unbraked trailer will cause the front of the vehicle to pitch down, but this effect is broadly similar to the braking of a loaded vehicle without a trailer (i.e. a vehicle carrying the cargo on its load bed).

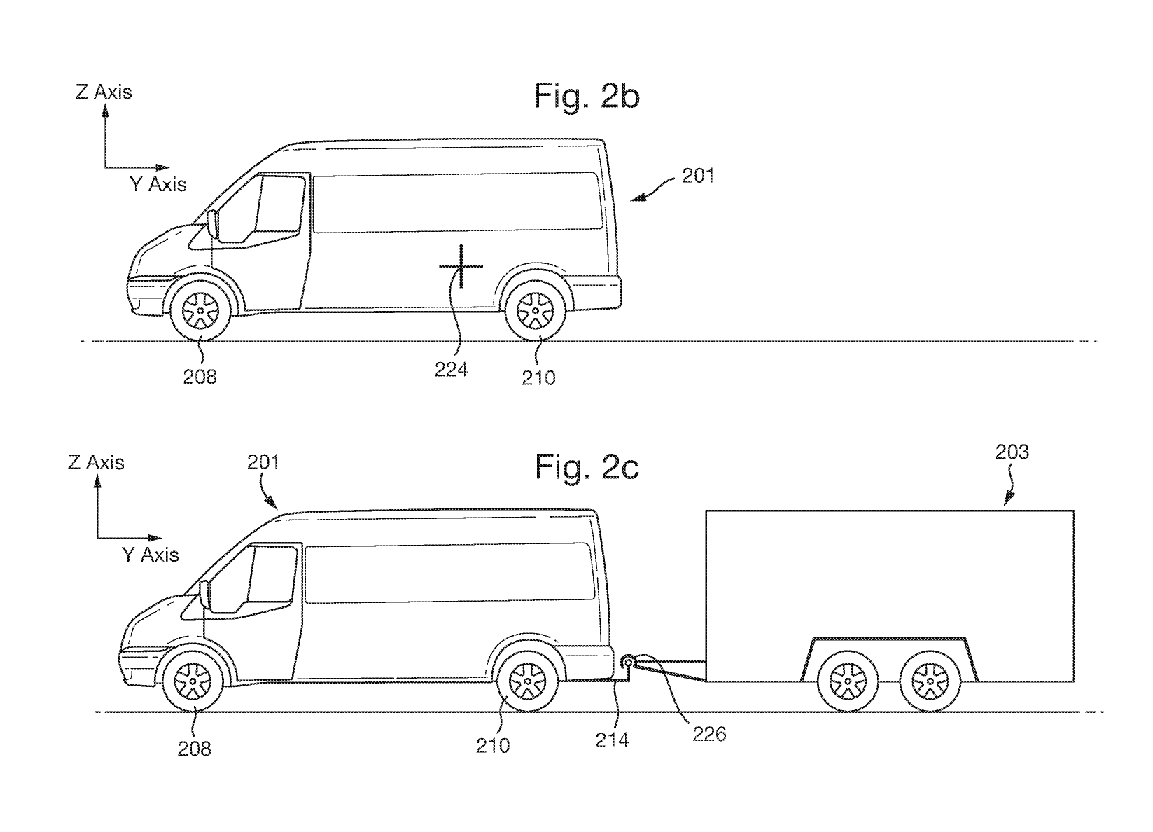

As is shown in FIGS. 3a and 3b, when the vehicle 301 turns, so that the trailer 303 and the vehicle 301 are no longer aligned, the trailer continues to apply a force 328 in the direction in which it is attempting to travel. Thus, components of the force 328 on the x axis and the y axis will be applied to the vehicle 301 by the trailer 303. In this situation, the vehicle body 322 is pushed sideways (x axis) as well as forwards (y axis), if the vehicle is decelerating, due to the continuing motion of the trailer. Thus, the vehicle body moves in a lateral and forwards direction relative to the wheel assemblies.

Displacement of the vehicle body relative to the front or rear wheel assemblies when a vehicle is towing a trailer will therefore differ from the displacement resulting from a load being carried on or in the body of the vehicle. As mentioned above, while displacement on the y axis is harder to definitively attribute to a load carried on a vehicle or a load towed by a vehicle, displacement of a vehicle body relative to the wheel assemblies of the vehicle in the lateral (x axis) direction or the vertical (z axis) direction may be used to indicate that a trailer is connected to a vehicle. Thus, by measuring the displacement of the vehicle body relative to at least one wheel assembly in at least one of the lateral and the vertical directions and processing the measurement, it is possible to determine if a trailer is connected to the vehicle.

Furthermore, when a trailer is being towed, it can exhibit a forward-backward rocking oscillation which is translated into an up-down movement at the rear of the vehicle via the tow bar. The movement of the vehicle body in a lateral direction (x axis) as well as the up and down movement (z axis) with respect to a wheel assembly can be measured and processed using Fast Fourier Transform (FFT) analysis to separate the frequency of the trailer oscillation from the natural frequency of the vehicle suspension. By performing FFT analysis on a signal produced by a wheel assembly sensor to establish whether there is one or more additional frequency being induced by a trailer, it is therefore possible to determine reliably whether a trailer is connected to the vehicle. The measured displacement of the wheel assembly relative to the vehicle body may therefore be processed by performing FFT analysis to detect oscillation of the vehicle body induced by the trailer and thereby determine whether a trailer is connected to the vehicle.

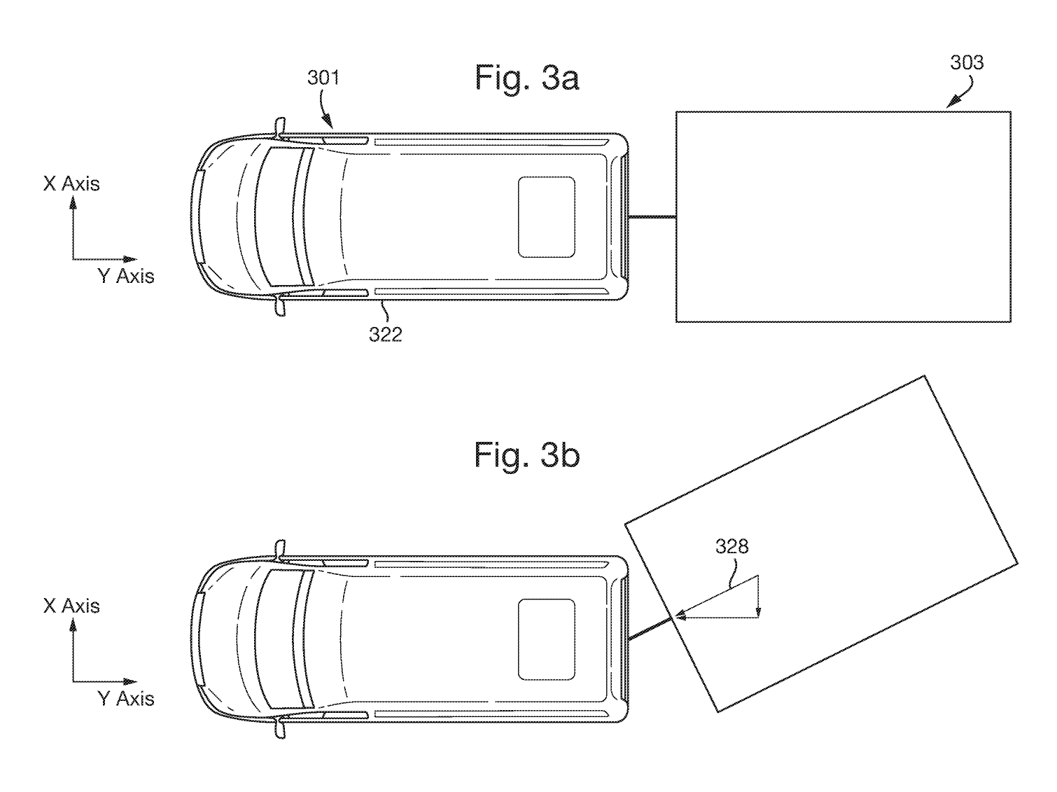

In a first arrangement shown in FIG. 4 (in view of FIGS. 1-3b), a trailer detection system 482 for a vehicle 401 is provided, wherein the detection system comprises a lateral sensor 430 which comprises a first sensor body 432 attached to the vehicle body 422 and a first probe 434 attached at a center point of an axle 454 of the wheel assembly 408, the first probe 434 being rotatably connected to the first sensor body 432. Similarly, there is provided a vertical sensor 436 which comprises a second sensor body 438 attached to the vehicle body 422 and a second probe 440 attached to the wheel assembly 408, the second probe 440 being rotatably connected to the second sensor body 438.

The vehicle body 422 and the wheel assembly 408 are suspended relative to one another using known vehicle suspension. Thus, motion of the wheel assembly 408 relative to the vehicle body 422 causes the first probe 434 to rotate relative to the first sensor body 432 via a first hinge 442, wherein the rotation of the first hinge 442 corresponds to the motion of the wheel assembly 408. The first hinge 442 is arranged along the y axis so as to rotate in the x-z plane. The first probe comprises a first section 444 and a second section 446, wherein the first section 444 is rotatably connected to each of the wheel assembly 408 and the second section 446, and the second section 446 is further rotatably connected to the first sensor body 432 via the first hinge 442. The first section 444 extends substantially parallel to the axle 454, and the second section 446 extends substantially parallel to the z direction, when the vehicle is in an equilibrium position (e.g. stationary).

The vertical sensor 436 is configured in a similar way to the lateral sensor. Thus, motion of the wheel assembly 408 relative to the vehicle body 422 causes the second probe 440 to rotate relative to the second sensor body 438 via a second hinge 452, wherein the rotation of the second hinge 452 corresponds to the motion of the wheel assembly 408. The second hinge 452 is arranged along the y axis so as to rotate in the x-z plane. The second probe comprises a third section 448 and a fourth section 450, wherein the third section 448 is rotatably connected to each of the wheel assembly 408 and the fourth section 450, and the fourth section 450 is further rotatably connected to the second sensor body 438 via the second hinge 452. However, in contrast to the lateral sensor, the third section 448 is provided substantially parallel to the z direction, and the fourth section 450 is provided substantially parallel to the axle 454.

Thus, the first hinge of the lateral sensor 430 will rotate more due to lateral components of displacement than vertical components of displacement, and the second hinge of the vertical sensor 436 will rotate more due to vertical components of displacement than lateral components of displacement. Consequently, the rotation of the first hinge 442 due to a lateral and vertical displacement of the vehicle body 422 with respect to the wheel assembly 408 will differ from the rotation of the second hinge 452. By using the values of rotation of the first hinge 442 and the second hinge 452, i.e. by comparing the values in a look-up table, which may be part of or in communication with a processor 480, it is possible to determine the lateral and vertical components of the displacement, either of which, or both in combination, can be used to determine if the trailer is connected to the vehicle 401.

The sensor may comprise a potentiometer or a rotation encoder to detect the rotation of the first and/or second hinge relative to the respective sensor body. The trailer detection system further comprises the processor 480 which is configured to communicate with the lateral sensor 430 and vertical sensor 436 and to process the detected rotation of the first and/or second hinge to determine whether a trailer (such as elements 3, 203 or 303) is connected to the vehicle 401.

To determine whether a trailer is connected to the vehicle 401, the detected displacement may be compared to a threshold value by the processor 480, where the threshold value is a predetermined value that indicates that a trailer is connected to the vehicle 401. When the sensor is measuring vertical displacement at a front axle of a vehicle 401, the threshold value of displacement may be greater than a normal range of operational displacement of the vehicle body 422 relative to the at least one wheel assembly 408 of the vehicle 401 without a trailer attached. When the sensor is measuring vertical displacement at a rear axle of a vehicle 401, the threshold value of displacement may be less than a normal range of operational displacement of the vehicle body 422 relative to the at least one wheel assembly 408 of the vehicle 401 without a trailer attached

Alternatively, the processor 480 may perform Fast Fourier Transform (FFT) analysis in order to make a determination as to whether a trailer is connected to the vehicle. FFT analysis allows frequencies of different signals to be separated from one another. The Fast Fourier Transform analysis may be used to calculate the frequency of oscillation of the vehicle 401. The processor 480 may be configured to determine if the calculated frequency of oscillation is indicative of a trailer (3, 203 or 303) being connected to the vehicle 401.

It will be appreciated that the wheel assembly 408 of these examples comprise an axle 454 and two wheels 456a, 456b of the vehicle 401. However, it should be appreciated that the wheel assembly 408 may comprise only one wheel 456a, 456b and a hub of the vehicle. There may be provided between two and four such wheel assemblies on a conventional vehicle. The wheel assemblies may each be suspended independently of one another.

Further sensors may be provided at each independently suspended wheel assembly. At least one sensor may be provided at a rear wheel assembly, and at least one sensor may be provided at a front wheel assembly (such as the front and rear wheel assemblies shown in FIGS. 1-3b). Each wheel assembly may be provided with more than one sensor. Thus, a second sensor may be provided, where the second sensor may be configured to detect at least one of a vertical and a lateral displacement of the vehicle body 422 relative to another wheel assembly associated with a different axle of the vehicle 401 from the first sensor.

Thus, the processor 480 may use the displacement measured by the first sensor and the displacement measured by the second sensor to make a determination as to whether a trailer is connected to the vehicle 401. Either the front or rear axle will be displaced from the vehicle body 422 more than the other of the front or rear axle when a trailer is connected to a vehicle 401. By comparing the displacement of a front and rear axle relative to the vehicle body 422, it is possible to distinguish a trailer attached to the rear of a vehicle 401 from a load provided within or on the vehicle 401.

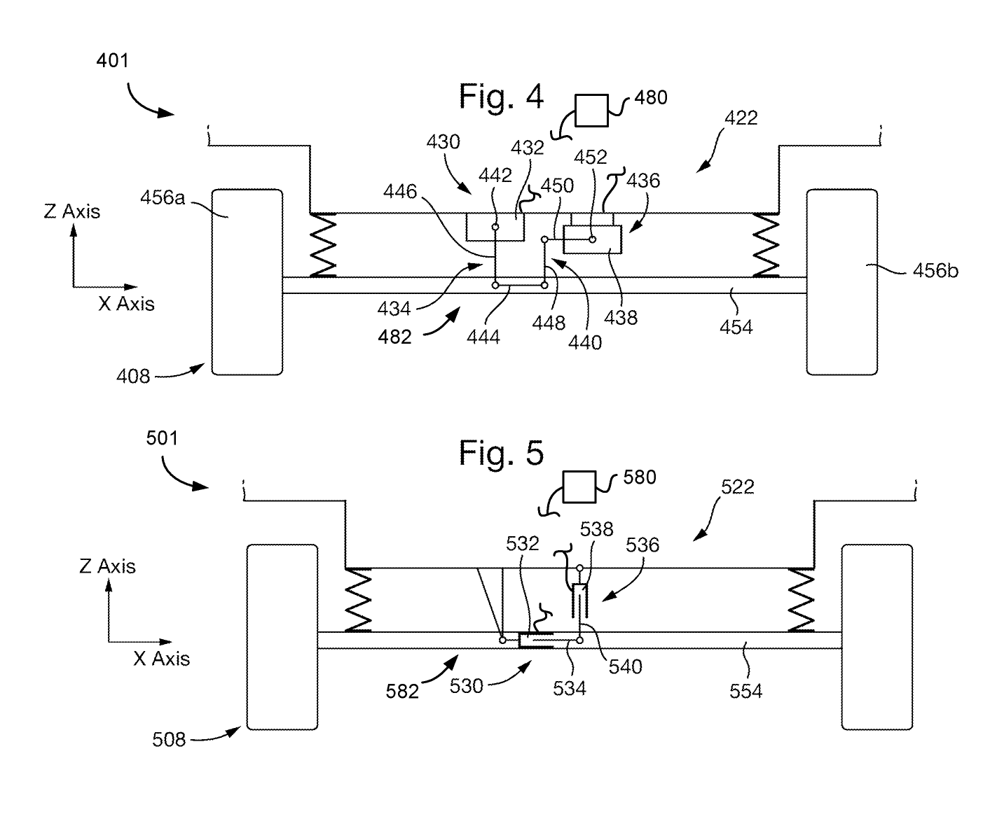

In the second arrangement shown in FIG. 5 (in view of FIGS. 1-3b), there is provided an alternative trailer detection system 582 comprising a lateral sensor 530 comprising a first sensor body 532 rotatably mounted to a bracket fixed to the vehicle body 522 and a first probe 534 rotatably mounted attached to a center point of an axle 554 of the wheel assembly 508. The first probe 534 is able to move relative to the first sensor body 532. The first probe 534 is slideably received within the first sensor body 532, and the lateral sensor 530 is configured to detect a translation of the probe relative to the sensor body. FIG. 5 also shows a vertical sensor 536 comprising a second sensor body 538 rotatably attached to the vehicle body 522 and a second probe 540 rotatably attached to the center point of the axle 554 of the wheel assembly 508. The second probe 540 is able to move relative to the second sensor body 538. The second probe 540 is slideably received within the second sensor body 538, and the vertical sensor is configured to detect a translation of the probe relative to the sensor body.

It will be appreciated that displacement of the vehicle body 522 with respect to the wheel assembly 508 in either the vertical or lateral direction will result in displacement of either probe relative to their corresponding sensor body. In the lateral sensor 530, lateral displacement will result in a greater displacement of the first probe 534 relative to the first sensor body 532 than that of the second probe 540 relative to the second sensor body 538. For vertical displacement, the reverse will be true. Thus, the displacement of the first probe 534 relative to the first sensor body 532 and the displacement of the second probe 540 relative to the second sensor body 538 will usually differ for the same overall displacement of the vehicle body 522 with respect to the wheel assembly 508. Thus, the two detected displacements can be used to determine the lateral and vertical components of displacement of the vehicle body 522 with respect to the wheel assembly 508.

A processor 580 is configured in the same manner as the processor described in relation to example 1, and is thus configured to process the detected displacement and to make a determination as to whether a trailer (such as elements 3, 203 or 303) is connected to the vehicle 501. Thus, it is possible to determine whether the trailer is connected to the vehicle using the detected displacement.

In view of FIGS. 4 and 5, it will be appreciated that any sensor may be used which is able to determine a displacement of the vehicle body 422/522 with respect to the wheel assembly 408/508, and the displacement processed in the manner stated herein in order to determine whether a trailer is connected to a vehicle 401/501. For example, the distance between a body 422/522 of a vehicle 401/501 and a wheel assembly 408/508 may be measured by a laser distance measurer as is known in the art. A laser distance measurer may be configured to measure the distance between the underside of a vehicle body 422/522 and a portion of the wheel assembly 408/508 in a vertical direction. Alternatively or additionally, a laser distance measurer may be configured to measure the distance between a fixed point on the vehicle body 422/522 and a wheel of the wheel assembly 408/508 in a lateral direction. Any distance measurement apparatus capable of measuring a distance between the vehicle body and a wheel assembly may be applied.

It will be appreciated by those skilled in the art that although the invention has been described by way of example, with reference to one or more exemplary examples, it is not limited to the disclosed examples and that alternative examples could be constructed without departing from the scope of the invention as defined by the appended claims.

1. A trailer detection system for a vehicle comprising:
a first sensor configured to detect at least one of a vertical and a lateral displacement of a vehicle body relative to at least one wheel assembly of the vehicle; and
a processor, configured to perform Fast Fourier Transform analysis on the detected displacement to make a determination as to whether a trailer is connected to the vehicle.

2. The trailer detection system of claim 1, wherein the Fast Fourier Transform analysis is used to calculate a frequency of oscillation of the vehicle, and the processor is configured to determine if the calculated frequency of oscillation is indicative of the trailer being connected to the vehicle.

3. The trailer detection system of claim 1 wherein the first sensor comprises at least one lateral sensor configured to detect the lateral displacement of the at least one wheel assembly relative to the vehicle body.

4. The trailer detection system of claim 1 including a second sensor configured to detect at least one of a vertical and a lateral displacement of the vehicle body relative to a second wheel assembly associated with a different axle of the vehicle from the first sensor.

5. The trailer detection system of claim 4, wherein the processor uses the displacement measured by the first sensor and the displacement measured by the second sensor to make a determination as to whether the trailer is connected to the vehicle.

6. The trailer detection system of claim 4, wherein at least one of the first sensor and the second sensor comprises at least one of a contactless proximity sensor and a contact sensor connected to both the vehicle body and the wheel assembly.

7. The trailer detection system of claim 6, wherein the contact sensor comprises a sensor body and a probe which is able to move relative to the sensor body, the sensor body being attached to at least one of the vehicle body and the wheel assembly and the probe being attached to the other of the vehicle body and the wheel assembly.

8. The trailer detection system of claim 7, wherein the probe is rotatably connected to the sensor body and to at least one of the vehicle body and the wheel assembly, and the sensor is configured to detect rotation of the probe relative to the sensor body.

9. The trailer detection system of claim 8, wherein the probe is rotatably connected by at least one of a hinge or a ball joint.

10. The trailer detection system of claim 8, wherein the sensor further comprises a potentiometer or a rotation encoder which detects rotation of the probe relative to the sensor body.

11. The trailer detection system of claim 7, wherein the probe is slideably received within the sensor body, and the sensor is configured to detect translation of the probe relative to the sensor body.

12. The trailer detection system of claim 4, wherein at least one of the first sensor and the second sensor is configured to detect both the vertical and the lateral displacement of the vehicle body relative to the at least one wheel assembly of the vehicle.

13. The trailer detection system of claim 1, wherein the first sensor is configured to detect one of the vertical and the lateral displacement of the vehicle body relative to the at least one wheel assembly of the vehicle, and a second sensor is provided to detect the other of the vertical and the lateral displacement of the vehicle body relative to the at least one wheel assembly of the vehicle.

14. The trailer detection system of claim 4, wherein the second sensor is configured to detect one of the vertical and the lateral displacement of the vehicle body relative to the second wheel assembly of the vehicle, and a third sensor is provided to detect the other of the vertical and the lateral displacement of the vehicle body relative to the second wheel assembly of the vehicle.

15. The trailer detection system of claim 1, wherein the wheel assembly comprises an axle extending across a centerline of the vehicle.

16. A method of performing trailer detection for a vehicle, the method comprising:
detecting at least one of a vertical and a lateral displacement of a vehicle body relative to at least one wheel assembly of the vehicle;
processing the detected displacement by performing Fast Fourier Transform analysis; and
determining whether a trailer is connected to the vehicle based on the Fast Fourier Transform analysis.

17. The method of claim 16, wherein the Fast Fourier Transform analysis is used for calculating the frequency of oscillation of the vehicle, and a processor is determining if the calculated frequency of oscillation is indicative of the trailer being connected to the vehicle.

18. The method of claim 16, further comprising detecting at least one of a vertical and a lateral displacement of the vehicle body relative to a second wheel assembly associated with a different axle of the vehicle, and determining whether the trailer is connected to the vehicle using the displacement of the wheel assembly and the second wheel assembly.
